(19) United States
(12) Patent Application Publication
(10) Pub. No.: US 2024/0098592 A1
(43) Pub. Date: Mar. 21, 2024

(54) AUTOMATIC DEPLOYMENT OF A LINEAR WIRELESS MESH COMMUNICATIONS NETWORK

(71) Applicant: COMMISSARIAT A L’ENERGIE ATOMIQUE ET AUX ENERGIES ALTERNATIVES, PARIS (FR)

(72) Inventors: Christophe JANNETEAU, GIF SUR YVETTE (FR); Michael BOC, GIF SUR YVETTE (FR)

(21) Appl. No.: 18/265,645

(22) PCT Filed: Nov. 26, 2021
(86) PCT No.: PCT/EP2021/083094

§ 371 Date: Jun. 6, 2023

(30) Foreign Application Priority Data
Dec. 14, 2020 (FR) FR2013143

(51) Int. Cl. H04W 36/00; H04W 36/30; H04W 36/32

(52) U.S. Cl. CPC H04W 36/035; H04W 36/304; H04W 36/322; H04W 84/18

(57) ABSTRACT

A device and a method for automatically deploying a communication network between a moving vehicle VM and a rear base BA, the moving vehicle moving from an initial position along a trajectory T. The deployment involves positioning a plurality of communication relay appliances along the trajectory of the VM to form, between the VM and the rear base, a two-way, linear wireless mesh communication network, such that the communications between the moving vehicle and the rear base maintain a communication link quality Q that is equal to or greater than a threshold value S. Each communication relay appliance is an autonomous mobile appliance, called Autonomous Robotic Communication Relay RCRA, capable of autonomously moving and of being positioned along the trajectory T followed by the VM in order to allow the quality of the communication link to be maintained.

### CROSS-REFERENCE TO RELATED APPLICATIONS

This application is a National Stage of International patent application PCT/EP2021/083094, filed on Nov. 26, 2021, which claims priority to foreign French patent application No. FR 2013143, filed on Dec. 14, 2020, the disclosures of which are incorporated by reference in their entirety.

### FIELD OF THE INVENTION

The invention is in the technical field of telecommunication networks, and more specifically relates to a method for automatically deploying a wireless mesh communication network with a view to maintaining wireless connectivity between a moving mission vehicle and a rear base.

### BACKGROUND

The technical problem addressed by the present invention is that of the degradation or the loss of wireless connectivity between a rear base (BA) and a moving mission vehicle (VM). A distance that is eventually too great between a BA and a moving VM means that quality connectivity can no longer be maintained between the BA and the VM when the only link between the two objects is a direct wireless link, for example, a Wi-Fi, Li-Fi type radio link or a radio link using other transmission technology.

In practice, such situations can be encountered when, for the requirements of a mission to be completed, the VM has to move over a fairly large surface (for example, in the case of inspecting an open area outdoors) or when the VM has to move in environments limiting the propagation of wireless communications (for example, in highly metallic environments that restrict the propagation of the radio signal, such as a building with reinforced concrete walls or the like).

There are numerous applications, and they require maintaining sufficient wireless connectivity quality between the moving VM and its rear base in order to be able to implement two-way routing of the data required by the mission of the VM between the VM and the BA, despite the movement of the VM.

Solutions approach this problem by proposing the construction of a multi-hop wireless interconnection network between a rear base and a moving vehicle. Thus, patent application WO 2015/086331 by the Applicant proposes setting up communication relay nodes between the BA and the VM as the VM moves. The communication relays forming the relay nodes of the multi-hop network between the VM and the BA are communicating objects conveyed by the VM, with said VM being able to deploy them, i.e., to place them on the ground, when this is necessary. The disadvantage of this solution is that it requires hardware adaptation of the VM that must convey the relays in order to ensure the deployment thereof. Moreover, the communicating objects deployed by the VM do not have the ability to adapt their location once placed on the ground.

Thus, a requirement exists for a solution that dispenses with the disadvantages of the known solutions and that allows quality wireless connectivity to be maintained between a Rear Base (BA) and a moving Mission Vehicle (VM), without limiting the possibilities of movement of the VM.

The present invention addresses these requirements.

### SUMMARY OF THE INVENTION

An aim of the present invention is a method for automatically deploying a telecommunication network, with a view to maintaining the wireless connectivity between a moving mission vehicle (VM) and a rear base (BA).

In general, the invention relies on a set of appliances, called “Autonomous Robotic Communication Relay” (RCRA), with each appliance being capable of moving autonomously along a trajectory followed by a VM and a set of appliances deployed along the trajectory of the VM forming a linear wireless mesh communication network (or multi-hop network) between the VM and the rear base.

Advantageously, the method of the invention allows automatic control of the positioning of each RCRA along the trajectory of a VM, as well as the addition, if necessary, of any new RCRA, so as to maintain the wireless connectivity between the VM and the BA, and to ensure that the connectivity is of sufficient quality for two-way routing of the data required within the context of the mission of the VM between the VM and the BA, despite the movement of the VM.

Advantageously, the method of the invention allows a VM, via the automatic deployment of RCRAs along its trajectory, to remain connected to a BA even if the direct connectivity between the VM and the BA is lost (for example, at the limit of radio signal coverage).

Thus, by virtue of the method of the invention, a VM can travel greater distances or can enter more hostile environments, such as highly metallic environments that limit the propagation of the radio signal, while maintaining quality connectivity with a BA for data transmission.

In one embodiment, the invention comprises a mode, called fallback mode, that allows, when a VM turns back along its initial trajectory, automatic fallback of the RCRAs that have been deployed along this same trajectory, and that allows progressive dismantling of the mesh network formed by the deployed RCRAs, as the RCRAs of the mesh network are removed once they are no longer necessary for maintaining quality connectivity between the VM and a BA.

The fallback mode is particularly advantageous since it allows the number of RCRAs to be deployed to be limited in order to allow a VM to join its initial point at the end of a mission (typically it allows this number to be halved compared to a configuration without a fallback mode).

In addition, the fallback mode is particularly beneficial when a VM circulates in an extremely restricted environment (for example, a corridor) that does not physically allow a VM and an RCRA to cross.

Advantageously, the present invention does not require any adaptation of a VM to ensure the deployment of relay nodes, RCRA, with these relay nodes being robotic appliances capable of moving autonomously in the environment. In addition, the movable robotic relay nodes (RCRAs) automatically adapt their location while the VM is moving in order to maintain quality connectivity between the VM and the BA.

Advantageously, with the device of the invention not requiring any hardware adaptation of the VM, its implementation is greatly facilitated, as well as its applicability to any type of application scenario. An implementation of the invention can be in the form of a generic wireless connectivity extension system capable of interfacing simply and very quickly with any type of VM.

There are multiple fields of industrial application of the invention and they cover, without limitation, robotic inspection, monitoring, intervention solutions for safety, defense, first aid, or more specific industrial requirements such as, for example, nuclear dismantling.

In order to achieve the desired results, a method is proposed for automatically deploying a communication network between a moving vehicle VM and a rear base BA, with the moving vehicle moving from an initial position along a trajectory T, the deployment involving positioning a plurality of communication relay appliances along the trajectory of the VM to form, between the VM and the rear base, a two-way, linear wireless mesh communication network, such that the communications between the moving vehicle and the rear base maintain a communication link quality Q that is equal to or greater than a threshold value S, with each communication relay appliance being an autonomous mobile appliance, called Autonomous Robotic Communication Relay RCRA, capable of autonomously moving and of being positioned along the trajectory T followed by the VM, the method comprising steps involving:
(a) determining when the communication link quality between the rear base and a last communication relay RCRA(N) positioned on the trajectory T is below the threshold value S, with said RCRA(N) being considered to be the Parent of the rear base BA, such that Parent(BA)=N;
(b) positioning a new communication relay RCRA(N+1) along the trajectory T, between the rear base BA and the last communication relay RCRA(N), with the position of the new communication relay RCRA(N+1) being determined to establish a communication link quality between the RCRA(N+1) and the BA at a value that is equal to or greater than the threshold value S;
(c) configuring the communication relays RCRAs of the network positioned on the trajectory T, the rear base BA and the moving vehicle VM, in order to determine that the new communication relay RCRA(N+1) becomes the Parent of the BA, such that Parent(BA)=(N+1), and to determine that the linear wireless mesh network between the VM and the rear base BA is updated with the addition of the new communication relay RCRA(N+1) positioned between the BA and the RCRA(N); and
(d) repeating steps (a) to (c).

According to alternative or combined embodiments:
the step of positioning a new communication relay RCRA(N+1) comprises a first step involving activating the movement of the new communication relay RCRA(N+1) from a reserve zone toward the initial position of the trajectory T, with the reserve zone consolidating a plurality of communication relays;
the step of configuring the communication relays RCRAs of the network positioned on the trajectory T comprises steps of configuring the new communication relay RCRA(N+1) involving:
   reconfiguring a routing table (406) of the RCRA(N+1) to indicate that the RCRA(N) is directly joinable and that it is the next relay for joining all the other RCRAs of the network and the VM;
   identifying that the Parent of the RCRA(N+1) is the RCRA(N), and identifying (708-3) that the Child of the RCRA(N+1) is the BA;
   activating a module (414) for receiving the trajectory T of the VM from the RCRA(N);
   activating a module (416) for transmitting the trajectory of the VM to the BA; and
   activating a module (418) for monitoring the quality of the direct link with its Parent, the RCRA(N);
the step of configuring the communication relays of the network positioned on the trajectory T comprises steps of configuring the last communication relay RCRA(N) positioned on the trajectory T, involving:
   reconfiguring a routing table (406) of the RCRA(N) to indicate that the RCRA(N+1) is directly joinable and that the BA is joinable via the new communication relay RCRA(N+1);
   identifying that the Child of the RCRA(N) is the RCRA(N+1); and
   reconfiguring a module (416) for transmitting the trajectory of the VM to activate the transmission of the trajectory to the new Child RCRA(N+1) of the RCRA(N);
the step of configuring the rear base BA, comprises steps involving:
   adding the new communication relay RCRA(N+1) to a list ‘L’ of the RCRAs integrated in the linear wireless mesh network;
   reconfiguring a routing table (306) of the BA to indicate that all the RCRAs included in the list ‘L’, other than the new communication relay RCRA(N+1), are joinable via the new communication relay RCRA(N+1), and that the moving vehicle VM is joinable via the new communication relay RCRA(N+1);
   identifying that the Parent of the rear base BA is the new communication relay RCRA(N+1); and
   configuring a module (310) for receiving the trajectory of the VM to activate the reception of the trajectory from the new Parent RCRA(N+1);
the step of configuring the new communication relay RCRA(N+1) further comprises a step involving transmitting the entire trajectory T of the VM to the new communication relay;
the step of configuring the communication relays RCRAs of the linear wireless mesh network further comprises steps allowing each relay positioned along the trajectory T of the VM to:
   monitor the quality of the communication link between itself and its Parent; and
   autonomously advance on the trajectory T when the quality of the link is below the threshold value S;
the monitoring step further comprises a step involving monitoring the distance between itself and its Parent, and the step of advancing involves advancing when the quality of the link is below the threshold value S and the distance between itself and its Parent is greater than a safe distance ds;
the method further comprises a step involving computing a new value S of the quality threshold before the configuration step;
the method further comprises steps allowing progressive and automatic fallback of the communication relays positioned on the trajectory T of the moving vehicle VM, when a VM turns back along its initial trajectory, with the fallback of the communication relays leading to dismantling of the linear wireless mesh network.

The invention also relates to a device for automatically deploying a communication network between a moving vehicle VM and a rear base BA, the moving vehicle moving from an initial position along a trajectory T, the deployment involving positioning a plurality of communication relay appliances along the trajectory of the VM to form, between the VM and the rear base, a two-way, linear wireless mesh communication network, such that the communications between the moving vehicle and the rear base have a communication link quality Q that is equal to or greater than a threshold value S, with each communication relay appliance being an autonomous mobile appliance, called Autonomous Robotic Communication Relay RCRA, capable of moving autonomously and of being positioned along the trajectory T followed by the VM, the device comprising means for implementing the steps of the method of the invention.

According to alternative embodiments of the device of the invention, the moving vehicle is a land or air or amphibious or aquatic vehicle, said vehicle being driven or remotely driven or self-driven.

In an advantageous embodiment, the two-way, linear wireless mesh communication network is implemented as a “Software Defined Networking” (SDN) oriented architecture comprising an SDN controller having a Northbound Interface and a Southbound Interface, placed on the rear base BA. The SDN controller is able to control, via its Southbound Interface, the configurations of SDN appliances made up of the BA, the VM and the set of RCRAs and is able to implement, in the form of an SDN service via its Northbound Interface, the steps of the method of the invention.

The invention also relates to a computer program product that comprises code instructions for carrying out the steps of the method of the invention, when the program is executed on a computer.

### BRIEF DESCRIPTION OF THE DRAWINGS

Further features and advantages of the invention will become apparent from the following description and the figures of the accompanying drawings, in which:

FIG. 1 illustrates various examples of the application context of the invention, implementing communication between a Mission Vehicle (VM) and a Rear Base (BA);

FIG. 2a illustrates a set of RCRAs deployed on the trajectory of a VM in one embodiment;

FIG. 2b illustrates the addition of an RCRA to the linear wireless mesh communication network between the BA and the VM of FIG. 2a;

FIG. 3 illustrates the main functional features of a rear base (BA) in one embodiment;

FIG. 4 illustrates the main functional features of an autonomous robotic communication relay (RCRA) in one embodiment;

FIG. 5 illustrates the main functional features of a mission vehicle (VM) in one embodiment;

FIG. 6a is a flowchart of the steps completed by an RCRA integrated in a linear wireless mesh communication network between a BA and a VM;

FIG. 6b is a flowchart of an alternative embodiment of the method of FIG. 6a;

FIG. 7 is a flowchart of the steps completed by a BA to integrate a new RCRA in a linear wireless mesh communication network between a BA and a VM;

FIG. 8a and FIG. 8b are flowcharts detailing the steps of the method of FIG. 7;

FIG. 9 is a flowchart of the steps completed by an RCRA in fallback mode; and

FIG. 10a and FIG. 10b are flowcharts detailing the steps completed by a BA for dismantling a network of RCRAs in fallback mode.

### DETAILED DESCRIPTION

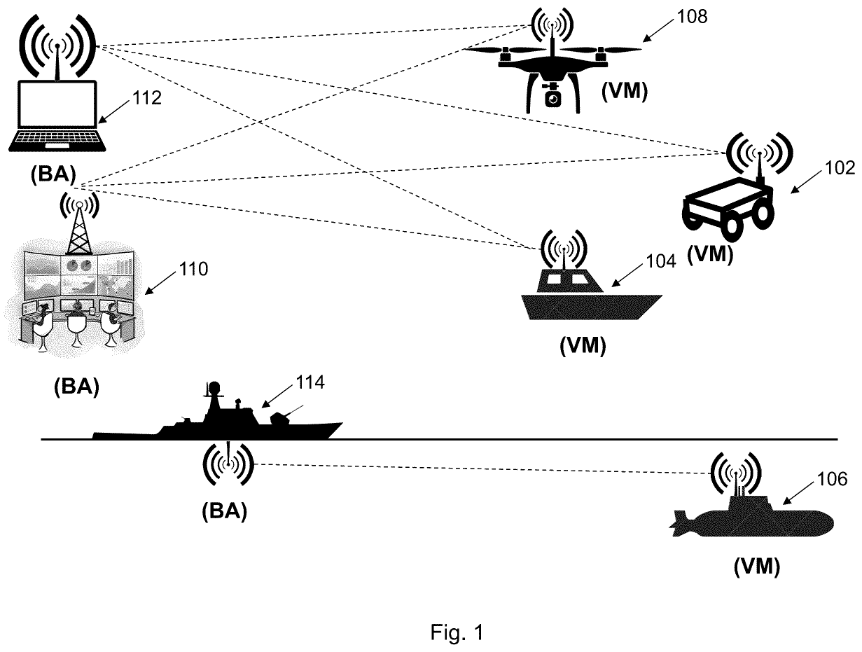

FIG. 1 illustrates various examples of the application context of the invention, implementing a communication between a Mission Vehicle (VM) and a Rear Base (BA).

Within the context of the invention, the term “mission vehicle” (VM) is to be understood in its broadest sense and can refer to any moving vehicle, whether this is a land (102), maritime (104, 106), air (108), civilian or military vehicle, etc., that moves in order to complete a mission.

A mission carried out by a VM can be, without limitation:
an emergency mission: such as inspecting a zone that has experienced an incident (for example, a fire, a flood, an earthquake, etc.), searching for and locating victims, etc.;
a security mission: such as monitoring a zone (for example, a border, etc.), detecting and locating a security alert (for example, unauthorized entries in a zone, etc.);
an industrial mission: such as undertaking the dismantling of a critical facility (for example, a nuclear site); or any other type of mission.

In addition, a vehicle within the context of the invention can be a vehicle driven by a person (104, 106) or remotely controlled (108) or even an autonomous vehicle (102) able to move alone in its environment according to a mission objective (for example, to follow a predefined trajectory in a given zone).

Thus, without limitation, a VM can be:
a flying vehicle such as a drone (remotely controlled or autonomous), an airplane, etc.;
a land vehicle, irrespective of its mode of locomotion (for example, equipped with wheels, tracks, etc.), such as a mobile inspection robot, etc.;
a floating vehicle such as a vessel, a drone, etc.;
an underwater vehicle, etc.

Within the context of the invention, a “rear base” (BA) can designate any system configured to communicate with a mission vehicle.

Communication between a BA and one or more VMs can be based on any type of wireless transmission technology, such as, for example, radio transmissions in any type of RF band (for example, ad-hoc Wi-Fi transmission), transmissions over the visible part of the electromagnetic spectrum (for example, Li-Fi transmissions) or even acoustic transmissions (for example, underwater).

A BA can be fixed (110, 112) or movable (114), for example, such as a vessel responsible for communicating with submarines.

Thus, a BA can assume various forms such as, for example:
a server on the Internet or a “cloud” responsible for receiving (and potentially storing and/or processing) the data gathered and transmitted by the VM as it moves;
a control or monitoring center, for example, responsible for monitoring one or more autonomous drones (for example, a fleet of drones); in this context, the data exchanges between the BA and the one or more VMs can be, for example, mission instructions (for example, a trajectory to be followed) transmitted to the one or more drones or even data (for example, videos, photos, event detection alerts, etc.) gathered by the one or more drones and transmitted to the BA;
a remote control console (or remote control) of a drone or robot for remotely controlling the drone/robot and for viewing a video stream captured by the drone/robot;
etc.

Thus, the present invention can be implemented with variants of these configurations and can be applied to the many stated scenarios or to others defined by new missions.

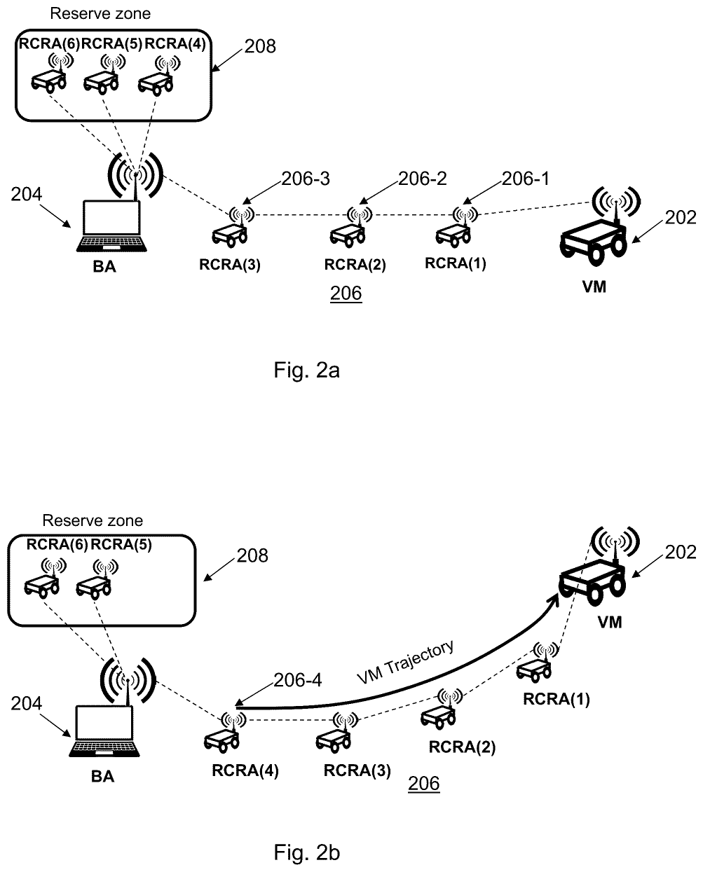

FIG. 2a illustrates an example of a communication network established between a VM (202) and a BA (204) by setting up a plurality of Autonomous Robotic Communication Relays (RCRA 206) deployed on the trajectory of the VM as it moves.

Advantageously, the method for deploying a communication network according to the invention allows automatic configuration of a linear wireless mesh communication network between the VM and the BA, this network can be made up of a plurality of RCRAs, thus allowing the wireless coverage between the VM and the BA to be extended and allowing the two entities to remain connected without limiting the movements of the VM.

An RCRA device according to the invention is an entity capable of autonomously moving along the trajectory followed by the VM and to park in a position that is computed to allow a multi-hop linear wireless communication to be established as a communication relay between the VM and the rear base. An RCRA according to the applications can be a terrestrial device, an aerial device that is hovering, such as a drone, a floating or underwater device.

According to alternative embodiments, the RCRAs can be equipped with any type of sensors or actuators potentially useful to the VM within the context of completing its mission. The VM can then, by virtue of the linear wireless network, gather the information originating from these additional sensors, thus allowing it to “enhance” its perception along its covered trajectory. In the same way, the VM can then, again by virtue of the linear wireless network, control the actuators of the RCRAs and thus “enhance” its capacity for action along its covered trajectory.

Thus, FIG. 2a shows a situation where the VM that has already moved on its trajectory since its departure when it was in direct communication with the BA, has required the deployment of three communication relays RCRA(1) (206-1), RCRA(2) (206-2), RCRA(3) (206-3) in order to maintain quality wireless connectivity between itself and the BA (204).

The method according to the invention allows automatic computation of the positioning of each RCRA to be deployed along the trajectory of the VM, as well as the addition, if necessary, of a new RCRA, so as to maintain the wireless connectivity between the VM and the BA and to ensure that this is of sufficient quality for two-way routing of the data exchanges between the VM and the BA despite the movement of the VM.

FIG. 2b illustrates a situation subsequent to FIG. 2a where the VM has moved, and it has been determined that, in order to maintain a sufficient level of quality of the communications, a new RCRA (206-4) had to be added to the mesh-hop linear wireless communication network established between the VM (202) and the BA (204).

The example used for FIGS. 2a and 2b is simplified in order to be able to describe the principles of the invention, but a person skilled in the art will understand that any other deployment of RCRAs in terms of the number and the position on the trajectory of a VM is not limited by this example.

In one embodiment, the RCRAs are consolidated in a zone, called reserve zone (208), from which they can leave in order to be autonomously positioned at the intended position that is computed as the VM moves. Thus, according to the illustrated examples, the reserve zone (208) contains three RCRAs on stand-by in FIG. 2a, and only contains two in FIG. 2b after sending the RCRA(4) to its computed position.

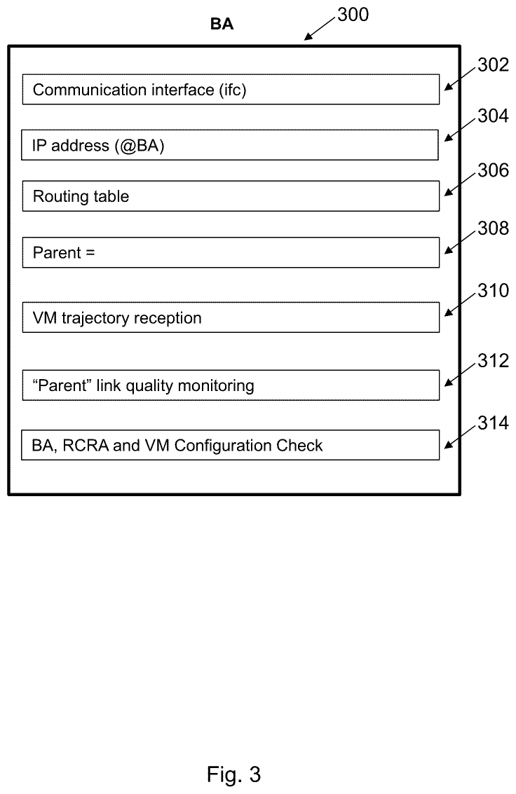

FIG. 3 illustrates a module (300) of the main functional features of a rear base (BA) allowing the method of the invention to be implemented in one embodiment.

The functional module (300) of a BA comprises a communication interface (ifc) associated with an IP address (IPv4 or IPv6) denoted “@BA” (304). This communication interface (302) allows the BA to communicate:
with the RCRAs located in the reserve zone and that are within direct wireless range of the BA (i.e., not requiring relaying of the communications);
with a VM at the start of the mission (when the BA and the VM are within direct wireless range);
with an RCRA positioned at the end of a queue (the last RCRA added to the linear wireless mesh network) and that is also within direct wireless range with the BA.

The functional module (300) of a BA also comprises a routing table (306) for routing the data streams from the BA to a VM, as well as the control commands for the VM configurations and RCRAs. The routing table makes it possible to indicate, for a given destination address (for example, the address of a VM), whether it is directly joinable via the interface ifc (302) or whether the communications need to be routed via a relay, which can be indicated by a “NextHop” reference in the routing table.

The routing table (306) can also include a default entry that allows all the streams to be routed to an IP address for which the routing table does not contain any specific routing entry.

At the start of a mission, the routing table of a BA is configured in “default” mode, as follows:

### Default→NextHop=<empty>via ifc

Thus, all the RCRAs in the reserve zone and the VM are joinable within direct wireless range via the interface ifc of the BA upon initialization.

The functional module (300) of a BA also comprises a sub-module (308) designated by the “Parent” field (308) allowing the connectivity relationship of the BA to be plotted to a VM, via any of the multiple RCRAs, through the linear wireless mesh communication network. At the start of a mission, the “Parent” field is configured with the identifier of the VM (for example, the IP address of the VM: @VM), and is then updated as the VM moves with the identifier of the last RCRA (for example, the IP address of this RCRA) added to the linear wireless network, with the last RCRA forming the first point of relaying communications addressed to the VM, and is therefore the “Parent” of the BA.

The functional module (300) of a BA also comprises a sub-module (310) for receiving the trajectory of the VM (with the trajectory being transmitted by the VM). The trajectory reception module (310) allows the BA to store the trajectory (T) of the VM from the initial starting point of the VM and throughout its movement. The trajectory data that is stored is transmitted by the BA to a new RCRA (initially in the reserve zone) in order to configure it with a view to integrating it with the linear wireless network. In one embodiment, the trajectory T of a VM can be shown in the form of a temporal sequence of successive positions of the VM determined at regular time intervals (for example, every 100 milliseconds). The trajectory T of the VM is not necessarily predefined, this can be adaptive according to the requirements and constraints of the mission to be completed by the VM. A VM, whether it is driven, remotely controlled, or autonomous, can, for example, adapt its trajectory in order to avoid an obstacle or simply because the objective of its mission (for example, a target zone to be reached, to be inspected, etc.) has changed.

The functional module (300) of a BA also comprises a sub-module (312) for monitoring the quality of the direct wireless communication link between the BA and its “Parent”. This module (312) allows the loss or the upcoming degradation of this direct link to be anticipated by analyzing the quality of the communication link, in order to allow an additional RCRA to be added to the linear wireless network when the quality drops below a certain threshold S.

In one embodiment, the threshold S is predefined at the start of the mission, it is the same for all the appliances of the linear wireless network (the BA, the RCRAs, the VM) and it remains constant throughout the mission.

In an alternative embodiment, the threshold S is predefined at the start of the mission, it is the same for all the appliances of the linear wireless network (the BA, the RCRAs, the VM), but it is (1) dynamically recomputed by the BA each time an RCRA is added to or removed from the linear wireless network and (2) dynamically pushed toward the appliances still present in the linear wireless network (the BA, the RCRAs, the VM) during the reconfigurations thereof. In this alternative embodiment, the computation of the new threshold S to be applied can be determined on the basis of a quality objective of the end-to-end communication between a VM and the BA (for example, a data rate or latency objective, etc.) and the number of RCRAs present in the linear wireless network.

By way of an illustration of this alternative embodiment, adding an RCRA, and therefore an additional level for relaying communications between a BA and a VM, can reduce the maximum available end-to-end data rate between the BA and the VM if the threshold S is not adjusted. However, by adjusting the threshold S so as to improve the quality of the connectivity of the direct link between each Child and their Parent within the linear wireless network (for example, by stipulating greater quality of the radio signal between the Child and the Parent, and therefore, potentially, a smaller maximum distance between the two), it is possible to increase the data rate available between each Child and their Parent, and therefore the available end-to-end data rate between the BA and the VM, and thus counteract the addition of an RCRA. Each of the RCRAs of the linear wireless network will readjust its position along the trajectory T of the VM to comply with this new threshold S once it has been configured.

The functional module (300) of a BA also comprises a sub-module (314) for controlling the configurations of the BA, of each of the RCRAs (located in the reserve zone or integrated in the linear wireless network) and of the VM.

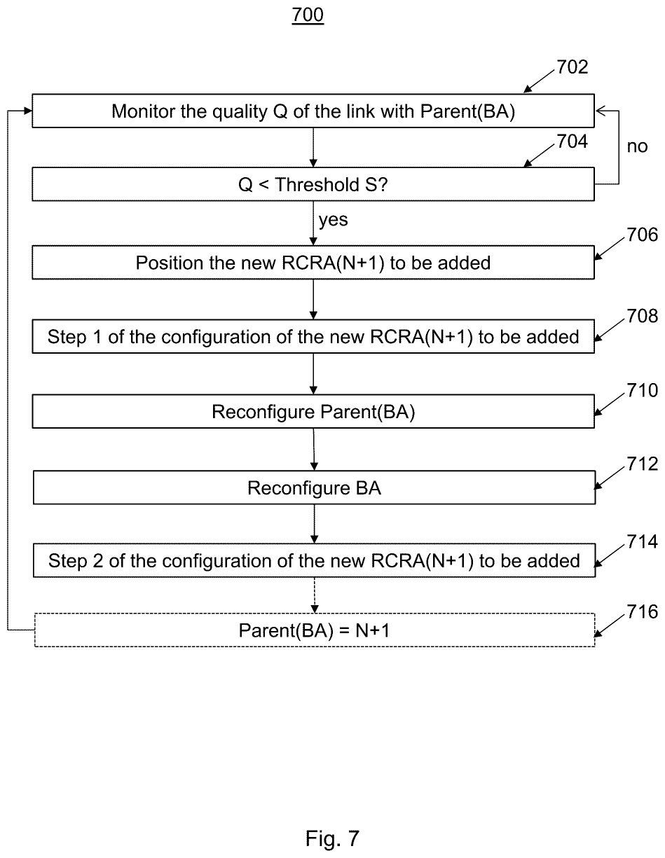

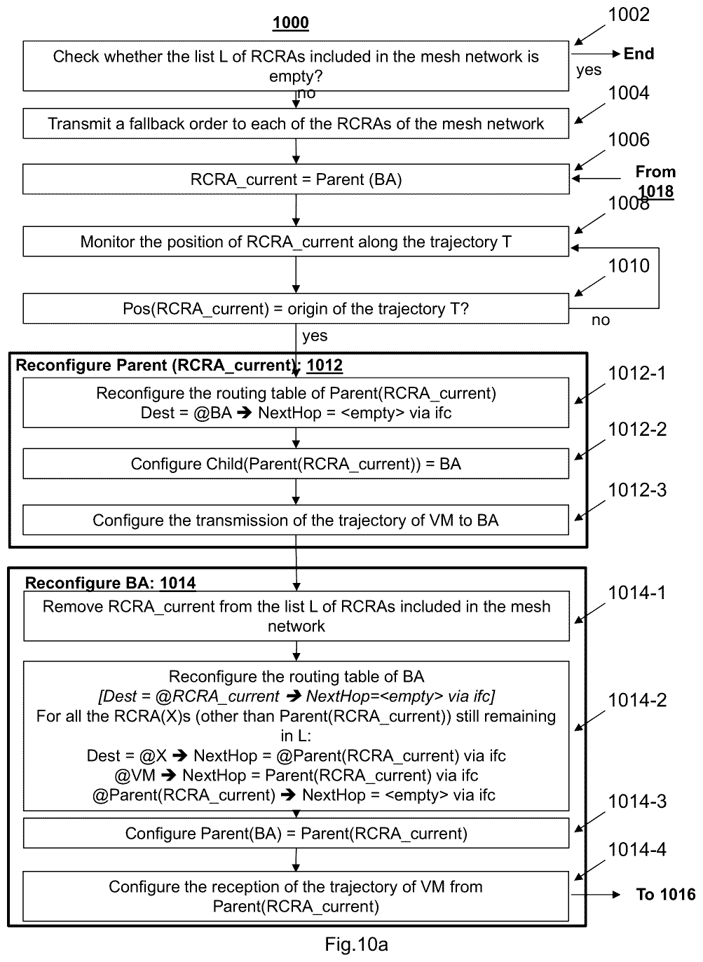

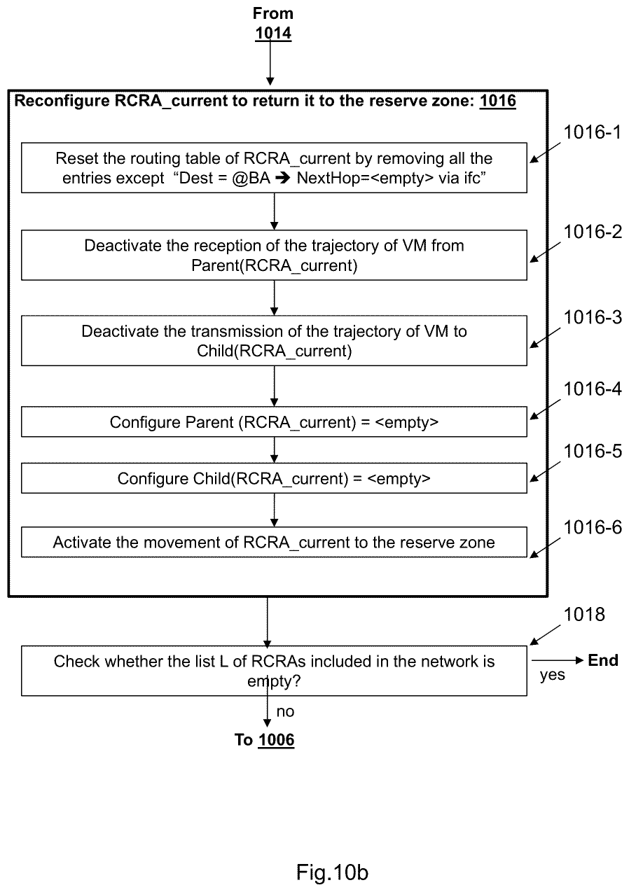

The configuration control module (314) comprises code instructions for executing operations for integrating, when this is necessary, a new RCRA on the linear wireless mesh communication network between the VM and the BA (method described with reference to FIG. 7), and for executing operations for progressively dismantling the network of RCRAs between the BA and the VM in fallback mode (method described with reference to FIGS. 10a and 10b).

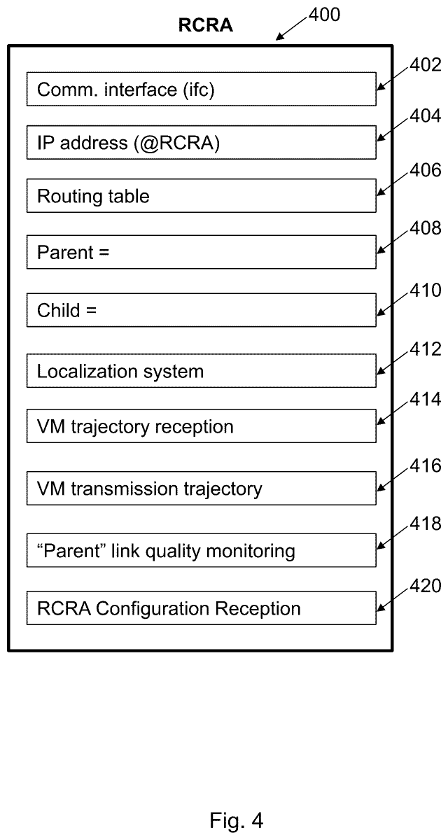

FIG. 4 illustrates a module (400) of the main functional features of an autonomous robotic communication relay (RCRA) allowing the method of the invention to be implemented in one embodiment.

The functional module (400) of an RCRA comprises a communication interface (ifc) associated with an IP address (IPv4 or IPv6), denoted “@RCRA” (404).

This communication interface (402) allows an RCRA to communicate:
with a BA at the start of the mission when it is in the reserve zone (with the BA being within direct wireless range);
with its neighbors (the BA, the VM or other RCRAs) according to its position in the linear wireless network once the RCRA has been added to the network.

The functional module (400) of an RCRA further comprises a routing table (406) allowing communications to be routed between a BA, a VM and the other RCRAs optionally present in the linear wireless network.

At the start of a mission, the routing table of an RCRA (which is then in the reserve zone) is configured to indicate that the BA is joinable within direct wireless range via the interface ifc of the RCRA, as follows:

### @BA→NextHop=<empty>via ifc

The functional module (400) of an RCRA also comprises two sub-modules (40, 410) denoted by the “Parent” (408) and “Child” (410) fields that are used to plot the connectivity relationship of a BA to a VM through the linear wireless mesh communication network when the RCRA is integrated in the network.

At the start of the mission, the Parent (408) and Child (410) fields of each RCRA (which are then in the reserve zone) are empty. Once an RCRA must be integrated in the linear wireless network, its Parent and Child fields are filled out with the identifiers of its neighbors in the network. The Parent field is populated with the identifier of the RCRA that is the neighboring RCRA upstream toward the VM (or is populated with the identifier of the VM itself if the RCRA is the first to be integrated in the network), and the Child field is populated with the identifier of a neighboring RCRA that will be the neighboring RCRA downstream toward the BA (or is populated with the identifier of the BA itself).

The functional module (400) of an RCRA also comprises a localization system (412) (which can be identical to that of a VM), allowing it to know its position in the environment in which it is moving at any instant. Advantageously, within the context of the invention, the localization system allows the RCRA to be able to be positioned along the trajectory T that it receives from the VM via a “VM trajectory reception” sub-module (414).

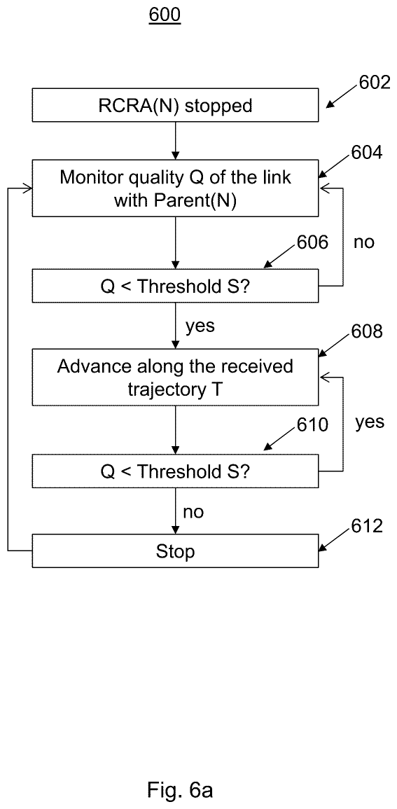

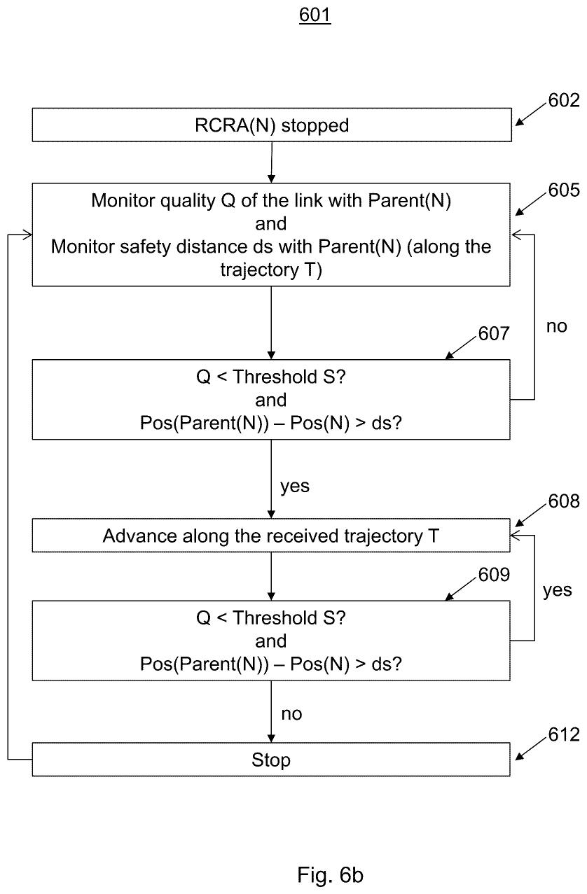

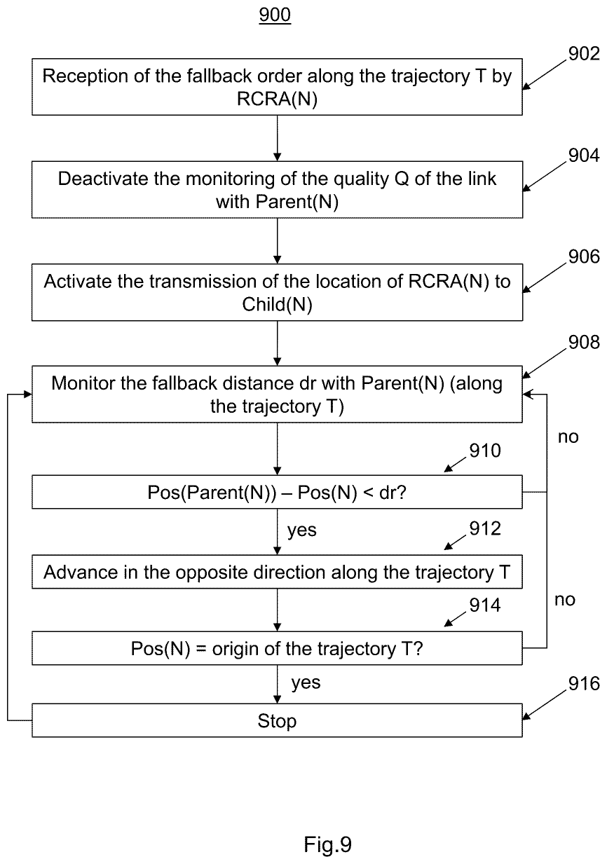

At the start of a mission, with all the RCRAs being in the reserve zone, none of them receives the trajectory T of the VM. Once an RCRA is integrated in the linear wireless network, it can then receive the trajectory T of the VM and autonomously advance along this trajectory in accordance with the implementation of sub-methods described with reference to FIGS. 6a and 9.

The functional module (400) of an RCRA also comprises a sub-module (416) for transmitting the trajectory T of a VM to its “Child” (the BA or the preceding neighboring RCRA to the BA in the linear wireless network). The module (416) for transmitting the trajectory T of a VM is used once the RCRA is integrated in the linear wireless network.

The functional module (400) of an RCRA further comprises a sub-module (418) for monitoring the quality of the direct wireless communication link between itself and its “Parent”. This module (418) is used once the RCRA is integrated in the linear wireless network, thus allowing this RCRA to anticipate the loss or the upcoming degradation of the direct communication link with its “Parent” and to adjust its position accordingly on the trajectory T of the VM (mainly with a view to approaching its Parent) so as to maintain quality connectivity between the RCRA and its Parent. This module is used in the method described with reference to FIG. 6a.

The functional module (400) of an RCRA further comprises a sub-module (420) for “receiving the RCRA configuration” transmitted by the BA. This module is activated by the method described in FIG. 7 of the operations of a BA for integrating a new RCRA in the linear wireless mesh communication network between the VM and the BA, when necessary. It is also activated by the method described in FIGS. 10a and 10b of the operations of a BA for progressively dismantling the network of RCRAs between the BA and the VM in fallback mode.

It should be noted that a change in the configuration of an RCRA is necessary once it is introduced into the linear wireless network (from the reserve zone), or it is removed from the linear wireless network (in order to reintegrate the reserve zone) or when another RCRA directly neighboring this RCRA must be integrated in or removed from the linear wireless network.

In one embodiment, an RCRA also can be equipped with obstacle detection or anti-collision systems to prevent it, during its autonomous navigation, from colliding with obstacles. Such systems can rely on various types of environment perception sensors such as cameras, radars, lidars or the like.

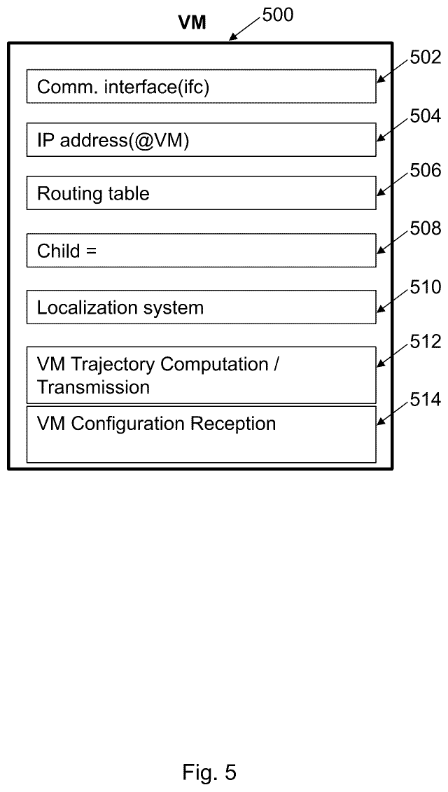

FIG. 5 illustrates a module (500) of the main functional features of a mission vehicle (VM) allowing the method of the invention to be implemented in one embodiment.

The functional module (500) of a VM comprises a communication interface (ifc) associated with an IP address (IPv4 or IPv6), denoted “@VM” (504). This communication interface (502) allows a VM to communicate:
with a BA at the start of the mission, with the BA and the VM being within direct wireless range;
with the RCRA at the head of the queue (the first added to the linear wireless mesh network) within direct wireless range with the VM, once the movement of the VM no longer allows the BA and the VM to communicate within direct wireless range.

The functional module (500) of a VM further comprises a routing table (506) allowing the data streams to be routed from the VM to the BA. This routing table makes it possible to indicate, for a given destination address (for example, that of the BA), whether it is directly joinable via the interface ifc or whether the communications need to be routed via a relay (indicated as “NextHop” in the routing table).

At the start of a mission, the routing table of a VM is configured to indicate that the BA is joinable within direct wireless range via the interface ifc of the VM, as follows:

### @BA→NextHop=<empty>via ifc

The functional module (500) of a VM also comprises a sub-module (508), denoted using the “Child” field, allowing the connectivity relationship to be plotted from the BA to a VM, via any of the multiple RCRAs, through the linear wireless mesh communication network.

At the start of a mission, the “Child” field is configured with the identifier of the BA (for example, the IP address of the BA: @BA), then it is updated with the identifier of the first RCRA (for example, the IP address of this RCRA) added to the linear wireless network and forming the first point of relaying the communications addressed to the BA (this RCRA is the “Child” of the VM).

The functional module (500) of a VM also comprises a localization system (510) allowing it to know its position in the environment in which it moves at any instant.

A localization system (510) equipping a VM (but also an RCRA) can be, for example:
a satellite positioning system: GPS, Galileo, Glonass, etc. In this case, the position information of the VM can be an absolute position coordinate with respect to the terrestrial reference frame (for example a triplet: longitude, latitude, altitude, etc.);
a system for localization via a radio infrastructure deployed on the ground as a UWB (Ultra-Wide Band) positioning infrastructure;
a viewing localization system using one or more cameras, notably via SLAM (Simultaneous Localization And Mapping) techniques. In this case, the position information of the VM can be relative position information with respect to a point of origin (for example, the position of the VM at the start of the mission); this information optionally can be converted into absolute position information once the position at the point of origin according to an absolute location reference frame is known (for example, the GPS coordinates of the original position);
a hybrid system mixing several localization techniques such as satellite systems, with SLAM, or systems using other types of sensors (inertial units, compasses, accelerometers, odometers, etc.).

Thus, various localization systems and techniques can be used as a supplement depending on the environment in which the VM moves, for example, by directly operating a GPS system in an external environment (where the GPS coverage is available) and by switching to a SLAM localization system (optionally coupled to other sensors) in an indoor environment (where the GPS coverage is not available).

The functional module (500) of a VM further comprises a module (512) for computing and transmitting its trajectory T to its “Child” (the BA or the first RCRA added to the linear wireless network).

In one embodiment, the trajectory T of a VM is shown in the form of a temporal sequence of successive positions of the VM, which are determined at regular time intervals (for example, every 100 milliseconds).

In the case of a GPS positioning system, the trajectory of a VM can be made up of a time sequence of triplets (longitude, latitude, altitude) determined at regular time intervals (for example, intervals of 100 milliseconds) from the initial position point of the VM at the start of the mission.

The functional module (500) of a VM further comprises a module (514) for receiving the VM configuration transmitted by the BA. This module is activated by the method described in FIG. 7 for the operations of a BA for integrating a new RCRA with the linear wireless mesh communication network between the VM and the BA, when this is necessary.

This module is also activated by the method described in FIGS. 10a and 10b for the operations of a BA for progressively dismantling the network of RCRAs between the BA and the VM in fallback mode.

FIG. 6a is a flowchart of steps (600) completed by an RCRA already integrated in a linear wireless mesh communication network, established between a BA and a VM, along the trajectory of a VM.

The method (600) is described for an ‘N’ RCRA, which can be any RCRA of the linear wireless network. The operations allow the ‘N’ RCRA to anticipate the loss or the upcoming degradation of the direct communication link with its Parent and to accordingly adjust its position on the trajectory T of the VM (with a view to approaching its Parent) so as to maintain quality connectivity between itself and its Parent, and therefore maintain the quality of the connectivity between the BA and the VM.

By default, the RCRA is stopped (602). By virtue of its module (418) for monitoring the quality of the direct wireless communication link between itself and its “Parent”, the RCRA evaluates (604) the quality Q of the direct connectivity between itself and its Parent, for example, at regular time intervals. If the quality drops below a predefined threshold S (branch ‘Yes’ of 606), then the RCRA sets into motion (608) and advances along the trajectory T of the VM with a view to approaching its Parent, otherwise the RCRA remains in the state (604) of monitoring the quality of the connectivity (branch ‘No’ of 606). The trajectory T of the VM is known by the RCRA because it receives it from its Parent via the “VM trajectory reception” module (414).

Several alternative embodiments are possible with respect to the step (606) of determining whether a threshold S has been exceeded, relative to the quality of the direct link between the ‘N’ RCRA and its Parent. Thus, for example, the determination can occur
on the basis of a single measurement of the quality directly compared to the threshold S;
on the basis of several consecutive measurements (for example, at regular time intervals) and of the computation of an average of this quality, then by comparing this computed average with the threshold S;
on the basis of several consecutive measurements (for example, 10 measurements at regular time intervals) and of the number of times that these measurements exceed the threshold S: if this number itself exceeds a predefined threshold (for example, 7 out of 10 times) then the quality of the link is considered to exceed the threshold S. This approach has the advantage of overcoming the possible variabilities of the channel for propagating signals between the RCRA and its Parent.

As it moves along the trajectory T, the method allows the RCRA to continue to evaluate (610) the quality of its direct connectivity between itself and its Parent, and, once the quality Q again exceeds the threshold S, the RCRA stops (612) once again.

Thus, the RCRA dynamically adapts its position along the trajectory T of the VM so as to maintain quality connectivity between itself and its Parent.

Different and multiple quality indicators Q of the link between an RCRA and its Parent can be used, such as, for example:
quality indicators associated with the level of the transmission signal (for example, a radio signal or an acoustic signal): the power of the signal received from the Parent, the RSSI (Received Signal Strength Indication);
quality indicators of the connectivity linked to the performance of the link, such as, for example:
   the MCS (Modulation and Coding Index) for estimating the theoretical data rate of the link;
   evaluating the available applicable data rate by taking into account the MCS and the data indicators transmitted (TX) and received (RX) over the link between the RCRA and its Parent;
   measuring the latency (for example, measuring the “Round Trip Time” (RTT)) between the RCRA and its Parent;
   etc.;
or any combination of these indicators.

With each RCRA of the linear wireless network applying this same method (600), the linear wireless network made up of all these RCRAs then allows quality connectivity to be maintained between a BA and a VM, as long as the last RCRA added to the wireless mesh network (i.e., closest to the BA) is not too far from the BA.

If the last RCRA added to the network is eventually, due to its movement, too far away from the BA, the method of the invention then allows a procedure (700) to be triggered for adding a new RCRA to the linear wireless network.

FIG. 6b is a flowchart of an alternative embodiment of the method of FIG. 6a where the identical steps use the same reference signs and are not described in detail.

The alternative embodiment in the method (601) of FIG. 6b involves an optional extension that also ensures the quality of the link of an RCRA with its Parent, to ensure that the RCRA complies with a minimum safety distance (ds) between itself and its Parent at any time.

The monitoring step (605) involves the RCRA monitoring the quality Q of the link, but also the distance between itself and its Parent.

An RCRA is only set into motion (608) if the quality of the link drops below the predefined threshold S and if the distance between itself and its Parent is greater than the predefined safety distance ‘ds’ (branch ‘Yes’ of step 607), otherwise the RCRA remains in the state of monitoring both quality and distance (605).

In this embodiment, each of the RCRAs broadcasts its own position (Pos) to its Child, for example, at regular intervals, and transmits the trajectory T of the VM to its Child.

Thus, each RCRA of the linear wireless network can compute the distance between itself and its Parent by knowing the position of its Parent (received therefrom) and its own position, determined by virtue of the localization system (412) integrated in the RCRA.

As it moves along the trajectory T, the method allows the RCRA to continue to evaluate (609) the quality of the direct connectivity between this RCRA and its Parent, as well as the minimum safety distance (ds) between itself and its Parent. When the quality Q again exceeds the predefined threshold S, or the minimum safety distance ‘ds’ is no longer followed, the RCRA stops (612) once again.

FIG. 7 is a flowchart of steps (700) completed by a BA in order to integrate a new RCRA (stored in the reserve zone) in a linear wireless mesh communication network established between a BA and a VM.

The method (700) is described by assuming that the linear wireless network already integrates a plurality ‘N’ of RCRAs, denoted RCRA(1), RCRA(2), RCRA(N), and positioned in this order, from 1 to N, from a VM to a BA along the trajectory T of the VM.

The operations (700) carried out by a BA (i.e., the method completed by a BA) for deciding whether a new RCRA(N+1) must be integrated, and if applicable integrating it with the linear wireless mesh communication network between the VM and the BA, involve:

Steps (702, 704): the BA monitoring (702) the quality of the link with its Parent (RCRA(N) in the example) and, if this drops below a certain predefined threshold S (branch ‘Yes’ of 704), allowing a loss or a degradation of the quality of the connectivity with the RCRA(N) to be anticipated, the BA then carries out the following steps:

Step (706): positioning the new RCRA(N+1) (initially located in the reserve zone) by activating its movement toward the initial position of the trajectory T of the VM (with the initial position of the trajectory T of the VM being the starting point of the VM at the start of the mission). This initial position is known to the BA, which receives it via its VM trajectory reception module (310).

Step (708): when the RCRA(N+1) has autonomously arrived from the reserve zone at the initial position of the trajectory of the VM, the BA proceeds to a first step of configuring the RCRA(N+1) with a view to integrating it in the linear wireless network between the BA and the RCRA(N).

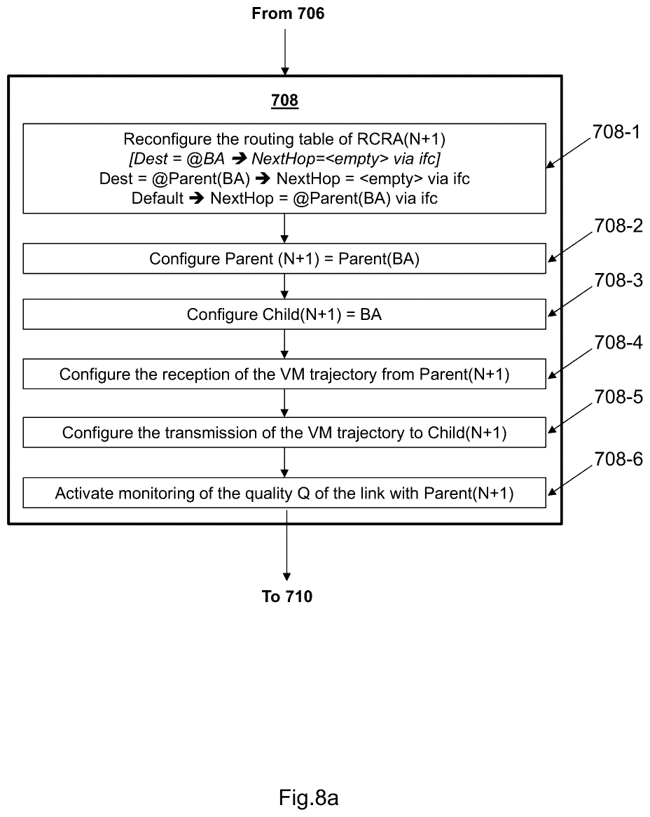

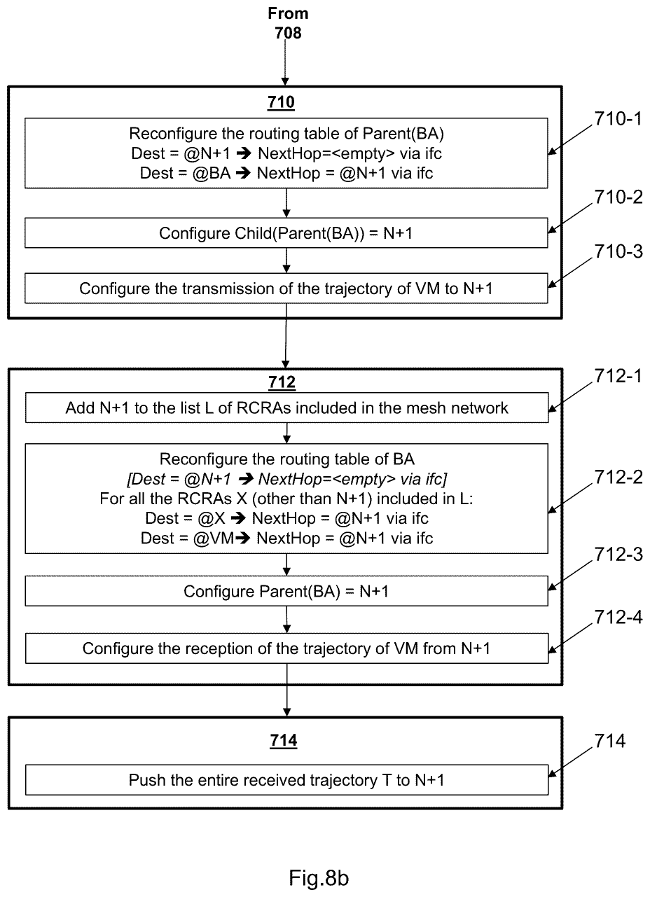

FIG. 8a shows an embodiment of the first step (708) of configuring the RCRA(N+1), and which involves:
Step (708-1): reconfiguring the routing table (406) of the RCRA(N+1) by indicating that:
   the RCRA(N) (currently the Parent of the BA) is directly joinable via its interface ifc; and
   the RCRA(N) is the “default nexthop” for joining all the other RCRAs of the network and the VM.
Step (708-2): configuring the module (408) by indicating that the Parent of the RCRA(N+1) is the RCRA(N).
Step (708-3): configuring the module (410) by indicating that the Child of the RCRA(N+1) is the BA.
Step (708-4): activating, on the RCRA(N+1), the module (414) for receiving the trajectory of the VM from the RCRA(N).
Step (708-5): activating, on the RCRA(N+1), the module (416) for transmitting the trajectory of the VM to the BA.
Step (708-6): activating, on the RCRA(N+1), the module (418) for monitoring the quality of the direct link with its Parent RCRA(N).

Thus, in this step the RCRA(N+1) is ready to integrate the linear wireless network, but it is not yet truly integrated therein since the reconfigurations of the RCRA(N) (the current Parent of the BA) and of the BA have not yet been set up.

With further reference to FIG. 7, the method continues after step (708) with a step (710) allowing the BA to reconfigure the RCRA(N) (its current parent) to notify it that a new RCRA(N+1) (the future Parent of BA) must now be taken into account between the BA and the RCRA(N).

FIG. 8b shows an embodiment of step (710), which involves:
Step (710-1): reconfiguring the routing table (406) of the RCRA(N) by indicating that:
   the RCRA(N+1) is directly joinable via its interface ifc;
   the BA is now joinable via the RCRA(N+1) (NextHop).
Step (710-2): configuring the module (410) by indicating that the Child of the RCRA(N) is the RCRA(N+1).
Step (710-3): reconfiguring the module (416) for transmitting the trajectory of the VM (initially transmitted to the BA) so that it is now transmitted it to its new Child, i.e., the RCRA(N+1).

With further reference to FIG. 7, the method continues after step (710) with a step (712) allowing the BA to reconfigure itself.

FIG. 8b shows an embodiment of step (712), which involves:
Step (712-1): adding the RCRA(N+1) to a list ‘L’ of the RCRAs integrated in the linear wireless mesh network.
Step (712-2): reconfiguring the routing table (306) of the BA by indicating that:
   for all the RCRAs other than the RCRA(N+1) included in the list ‘L’ (i.e., included in the linear wireless network), these are joinable via the RCRA(N+1) (NextHop);
   the VM is now joinable via the RCRA(N+1) (NextHop).
Step (712-3): configuring the module (308) by indicating that the Parent of the BA is now the RCRA(N+1).
Step (712-4): configuring the VM trajectory reception module (310) (initially transmitted from the RCRA(N)) to now receive the trajectory from its new Parent, the RCRA(N+1).

With further reference to FIG. 7, the method continues after step (712) with a step (714) allowing the BA to proceed to a second step of configuring the RCRA(N+1), which is now added to the linear wireless network. As illustrated in FIG. 8b, this second step of configuring the new RCRA(N+1) involves pushing (i.e., causing it to reach; transmitting to) the entire trajectory of the VM to this RCRA(N+1) that has already been received by the BA. By virtue of this information and of the upcoming updates of the location of the VM that will be received directly by the RCRA(N+1) (by virtue of its activated reception of the trajectory of the VM from its Parent RCRA(N)), the RCRA(N+1) will know the complete trajectory of the VM from the start of the mission until the instant ‘t’.

Once the method (700) completed by a BA is complete, the linear wireless network between the BA and the VM was updated with the addition of an RCRA(N+1) that is positioned between the BA and the RCRA(N). The RCRA(N+1) is now the Parent of the BA (716).

FIG. 9 is a flowchart of the steps completed by an RCRA integrated in a network, in fallback mode.

In one advantageous embodiment, the present invention also comprises a fallback mode allowing, when a VM turns back along its initial trajectory, automatic fallback of the RCRAs positioned along this same trajectory and dismantling of the mesh network formed by the RCRAs. The dismantling is progressive via the removal of the RCRAs from the mesh network as they are no longer necessary for maintaining the quality connectivity between the VM and the BA.

This embodiment is particularly beneficial since it allows the number of RCRAs to be deployed to be limited (typically halving this number) in order to allow the VM to rejoin its initial point at the end of the mission. In addition, it is particularly beneficial when the VM circulates in an extremely restricted environment (like a corridor) that does not physically allow a VM and an RCRA to cross.

The fallback mode is triggered on the initiative of a BA when a VM has to turn back along its initial trajectory. The BA then transmits a “fallback order” to each of the RCRAs of the linear wireless network, which order will then initiate the method (900) described with reference to FIG. 9 on each of the RCRAs receiving this message.

The method (900) begins upon reception (902), by an RCRA(N) integrated in the linear wireless network, of a message indicating a fallback order along the trajectory T of a VM, with the RCRA(N) then being stopped or then stopping if it was moving.

In a subsequent step (904), the method allows the RCRA(N) to deactivate its module (418) for monitoring the quality of the link with its Parent, and then continues with a step (906) allowing the RCRA(N) to activate the module (412) for transmitting its location to its Child.

In a subsequent step (908), the method allows the reception of the location of the Parent of RCRA(N) to be activated, and, on the basis of this information and of its own location of RCRA(N), allows a regular computation to be carried out (910) of the distance between itself, RCRA(N), and its Parent.

Once this distance drops below the threshold of a predefined fallback distance (dr), the method allows (912) the RCRA(N) to turn on (move) in the opposite direction, along the trajectory T previously received from the VM, and to begin to fallback to the point of origin of the trajectory T. When the RCRA(N) moves, it continues to monitor the distance between itself, RCRA(N), and its Parent and stops its movement once this distance again exceeds the fallback distance (dr); the method then loops back to step 910.

The method allows the RCRA(N) to determine (914) when it has joined the original position of the trajectory T of the VM, and to stop (916).

The removal of the linear wireless network from an RCRA is implemented by the BA in accordance with the method (1000) described with reference to FIGS. 10a and 10b.

FIG. 10a and FIG. 10b are flowcharts showing steps completed by a BA for dismantling a network of RCRAs in fallback mode, according to the following steps involving:

Step 1002: the BA checks that the linear wireless network actually contains at least one RCRA (i.e., it checks that the list L is not empty). If this is not the case, no dismantling is required and the method stops immediately.

Step 1004: if the list L actually is not empty, the BA transmits a fallback order to each of the RCRAs of the linear wireless network to initiate their fallback modes, with said RCRAs initiating the method of FIG. 9.

Step 1006: the BA then activates the reception of the location of its Parent (RCRA_current, in fallback mode along the trajectory T of the VM).

Steps 1008, 1010: the BA monitors (1008) the location information until it detects (1010) that its Parent has reached the original point of the trajectory T of the VM.

Step 1012: the BA then triggers the reconfiguration of the Parent of its Parent (i.e., the Parent(RCRA_current)) by means of the following steps:
1012-1: reconfiguring the routing table of the Parent(RCRA_current) to indicate that the BA is now joinable within direct range via its interface ifc;
1012-2: reconfiguring the Child of Parent(RCRA_current) field to indicate that its Child is now the BA; and
1012-3: reconfiguring the transmission of the trajectory of the VM to its new Child (i.e., the BA, as a replacement for the RCRA_current).

The method continues with a step (1014) allowing the BA to reconfigure itself, by means of the following steps:
1014-1: removing the RCRA_current from the list L of the RCRAs included in the linear wireless network;
1014-2: reconfiguring its routing table (that of BA) to indicate that:
   now all the RCRAs remaining in the linear wireless network (i.e., present in the list L) and other than the Parent(RCRA_current) are joinable via the Parent(RCRA_current);
   the VM is now joinable via the Parent(RCRA_current) (NextHop);
   the Parent(RCRA_current) is joinable within direct wireless range via the interface ifc of the BA, as follows:
   “@VM→NextHop=Parent(RCRA_current) via ifc”; and
   “@Parent(RCRA_current)→NextHop=<empty>via ifc”.
1014-3: reconfiguring its Parent field to indicate that its Parent is now Parent(RCRA_current); and
1014-4: reconfiguring the reception of the trajectory of the VM from its new Parent (=Parent(RCRA_current)).

The method continues with a step (1016) allowing the BA to reconfigure the RCRA_current, in order to make it pass into the reserve zone, by means of the following steps:
Step 1016-1: resetting the routing table of the RCRA_current, by deleting all the entries except that indicating that the BA is directly joinable via its interface ifc;
Step 1016-2: deactivating the reception of the trajectory of the VM from the Parent(RCRA_current);
Step 1016-3: deactivating the emission of the trajectory of the VM to the Child(RCRA_current);
Steps 1016-4, 1016-5: resetting the Parent and Child fields of the RCRA_current to “empty”; and
Step 1016-6: activating the movement of the RCRA_current to a specific point of the reserve zone.

The method continues with a step (1018) allowing the BA to check whether or not the list L of RCRAs included in the network is empty, and to loop back to the dismantling steps (to 1006) as long as an RCRA remains in the linear wireless network (i.e., as long as the Parent of the BA is not the VM), or to terminate when the list is empty.

Advantageously, at all times, a BA can interrupt the fallback mode and switch back into the normal mode by transmitting an “end of fallback order” to all the RCRAs still present in the linear wireless network (i.e., still present in the list L). Upon reception of this “end of fallback order”, each of the RCRAs reconfigures itself to transition from the fallback mode to the normal mode, and the BA also similarly reconfigures itself.

In an alternative embodiment of the invention, the fallback mode can be initiated by a BA even if a VM does not have to turn back to its initial position. This can occur, for example, in a scenario where a VM has reached a final position and where the communication link between the BA and the VM is no longer necessary. In this case, the BA can decide to proceed with the fallback of the various RCRAs of the linear wireless network according to the methods of FIGS. 9 and 10a-10b, considering that the head RCRA (that which was within direct range of the VM) then acts as the VM.

In an alternative embodiment, the BA, the VM and the RCRAs integrated in the linear wireless network can implement an additional functionality so as to enhance the durability of the network when faced with a failure of one or more RCRAs, and thus to allow automatic reconfiguration of the linear wireless network in order to maintain quality connectivity between the VM and the BA.

A failure of an RCRA making the network inoperative can be due to various causes such as, for example, the failure or the destruction of the RCRA (for example, in a military application/defense scenario).

This additional sub-method of automatically reconfiguring the linear wireless network, in the event of the failure of one or more RCRAs, is implemented by each of the appliances (BA, VM and RCRAs) forming part of the linear wireless network. The RCRAs have been integrated in the linear wireless network in an order corresponding to their identification number, such that the RCRA(1) is the Child of the VM, the RCRA(2) is the Child of the RCRA(1), etc., and the IP address of each RCRA can be directly computed/derived from its identifier.

With these prerequisites, the sub-method of reconfiguring the network in the event of a failure can be locally set up completely autonomously by each appliance of the linear wireless network (the BA, the VM and the RCRAs) because each one is able to determine the identifiers of its second level neighbors, and on this basis is able to self-reconfigure according to the sub-method, which involves:
each appliance monitoring the presence of its Parent (i.e., if the field is not empty) and its Child (i.e., if the field is not empty) within the linear wireless network, so as to detect a possible failure thereof. To this end, the appliance (for example, an RCRA(N)) can transmit, at regular time intervals, a presence test message (for example, a message of the “ICMP Echo Request” type) to its Parent and to its Child, and in return can wait for a reply message to this test of each of them (for example, a reply message of the “ICMP Echo Reply” type). If the appliance does not receive any reply from one of its direct neighbors (Parent or Child) over a predetermined time period, and typically greater than the interval for sending the test messages, the appliance can deduce therefrom that the neighbor in question is faulty.
once an appliance (for example, an RCRA(N)) detects that one of its direct neighbors (for example, its Parent, an RCRA(N−1)) is faulty, it initiates a self-reconfiguration procedure so as to now consider that its second level neighbor in the direction of the faulty appliance (in this example, this second level neighbor is therefore the Parent of the Parent of RCRA(N), that is RCRA(N−2)) replaces the faulty node. The RCRA(N) then considers that its new Parent now must be RCRA(N−2) and no longer the RCRA(N−1). In the example, the RCRA(N) self-reconfigures by means of the following steps:
   updating its Parent field to indicate that its Parent is the RCRA(N−2);
   reconfiguring its routing table by replacing the IP address of the RCRA(N−1) with that of the RCRA(N−2) in all the inputs where the first one appears;
   reconfiguring the reception of the trajectory of the VM so that it occurs from the RCRA (N−2) and no longer via the RCRA (N−1); and
   reconfiguring the monitoring of the quality of the direct link so that this now occurs with its Parent RCRA(N−2) and no longer with the RCRA(N−1).

It is important to note that the RCRA(N−2) that itself will also apply this same sub-method, and therefore will also detect the failure of the RCRA(N−1), i.e., its Child, will also self-reconfigure so as to consider that the RCRA(N) becomes its new Child as a replacement for RCRA(N−1), which is faulty. Thus, the linear wireless network has self-reconfigured itself automatically, while excluding the faulty RCRA(N−1), so as to maintain quality connectivity between the BA and the VM.

In the particular case whereby the faulty appliance is the last RCRA added to the linear wireless network (for example, an RCRA(X)), which is therefore the Parent of the BA, then the RCRA(X−1), i.e., the Parent of the faulty node, can detect the failure of the RCRA(X), but it is unaware of the fact that the BA is actually the Child of the faulty node. It will reconfigure itself autonomously based on the assumption that its new Child must be the RCRA(X+1), whereas this RCRA is not yet integrated in the linear wireless network. Furthermore, within the context of this sub-method, the BA adopts an additional behavior involving, when it also detects the failure of its Child (RCRA(X)), adding (from the reserve zone) the new RCRA(X+1) to the linear wireless network, in accordance with the method described with reference to FIG. 7. Thus, the overall connectivity is maintained between the BA and the VM via this addition of the RCRA(X+1) and the reconfiguration of the RCRA(X−1).

In the particular case whereby the faulty equipment is the first RCRA (i.e., the RCRA(1)) added to the linear wireless network, its Child, the RCRA(2), when it detects this failure, will understand that its new Parent now must be the VM, since the RCRA(0) does not exist.

One advantageous embodiment of the invention is based on an SDN (Software Defined Networking) oriented architecture. This architecture is based on an SDN controller installed on the BA and able to control, via its “Southbound Interface”, the configurations of a set of SDN appliances, which are then, within the scope of the invention (see FIG. 2a), the BA (204), the VM (202) and the set of RCRAs (206).

In this SDN implementation, the methods described above with reference to FIGS. 7 and 10a-10b, implemented by the BA, thus can be implemented in the form of an SDN Service (on the BA level) interfacing with the SDN controller via its Northbound Interface, so as to control the configurations of the various SDN appliances joinable via the Southbound Interface of the SDN controller.

This SDN service is thus responsible for detecting that a reconfiguration of the linear wireless network is necessary and then for controlling this reconfiguration, by setting-up reconfigurations on the BA, the VM and the various affected RCRAs, for
operations of the BA for integrating a new RCRA in the linear wireless mesh communication network between the VM and the BA, when necessary;
operations of the BA for progressively dismantling the network of RCRAs between the BA and the VM in fallback mode.

In this SDN implementation, the methods described above with reference to FIGS. 6a, 6b and 9, implemented by an RCRA integrated in the linear wireless network, either in the normal mode (FIG. 6a or 6b) or in the fallback mode (FIG. 9), can be implemented in two different ways:
either via a software module on each RCRA;
or in the form of an SDN service on the BA, with this SDN service interfacing with the SDN controller via its Northbound Interface so as to be able to control the behavior of the RCRAs integrated in the linear wireless network (with these RCRAs being SDN appliances joinable via the Southbound Interface of the SDN controller). This control of the behavior of the RCRAs then allows the operations of the aforementioned methods to be carried out.

1. A method for automatically deploying a two-way, linear wireless mesh communication network between a moving vehicle VM and a rear base BA, with the moving vehicle moving from an initial position along a trajectory T, the deployment involving creating a queue of communication relay appliances along the trajectory T of the VM, such that the communications between the moving vehicle and the rear base maintain a communication link quality Q that is equal to or greater than a threshold value S while the VM is moving, with each communication relay appliance N of the queue being an autonomous mobile appliance, called Autonomous Robotic Communication Relay and denoted RCRA(N), capable of moving autonomously, the method comprising steps involving:
(a) determining when the communication link quality between the rear base and an autonomous robotic communication relay RCRA(N) positioned at the end of the queue on the trajectory T is below the threshold value S, with the position at the end of the queue being that closest to the BA and said RCRA(N) being considered, in a Parent-Child connectivity relationship, to be the Parent of the rear base BA;
(b) sending a new autonomous robotic communication relay denoted RCRA(N+1) to be positioned along the trajectory T, between the rear base BA and the autonomous robotic communication relay RCRA(N) positioned at the end of the queue, with the position of the new autonomous robotic communication relay RCRA(N+1) being determined to establish a communication link quality between said new autonomous robotic communication relay RCRA(N+1) and the BA at a value that is equal to or greater than the threshold value S;
(c) configuring: the autonomous robotic communication relays denoted RCRAs already positioned on the trajectory T, the rear base BA, and the moving vehicle VM, in order to determine that the new autonomous robotic communication relay RCRA(N+1) becomes the Parent of the BA, and to determine that the linear wireless mesh network between the VM and the rear base BA is updated with the addition of the new autonomous robotic communication relay RCRA(N+1).

2. The method as claimed in claim 1, wherein the step of sending a new autonomous robotic communication relay RCRA(N+1) comprises a first step involving activating the movement of the new autonomous robotic communication relay RCRA(N+1) from a reserve zone toward the initial position of the trajectory T, with the reserve zone consolidating a plurality of autonomous robotic communication relays.

3. The method as claimed in claim 1, wherein the step of configuring the autonomous robotic communication relays RCRAs of the network positioned on the trajectory T comprises steps of configuring the new autonomous robotic communication relay RCRA(N+1) involving:
reconfiguring a routing table of the RCRA(N+1) to indicate that the RCRA(N) is directly joinable and that it is the next relay for joining all the other RCRAs of the network and the VM;
identifying that the Parent of the RCRA(N+1) is the RCRA(N), and identifying that the Child of the RCRA(N+1) is the BA;
activating a module for receiving the trajectory T of the VM from the RCRA(N);
activating a module for transmitting the trajectory of the VM to the BA; and
activating a module for monitoring the quality of the direct link with its Parent, the RCRA(N).

4. The method as claimed in claim 1, wherein the step of configuring the autonomous robotic communication relays of the network positioned on the trajectory T comprises steps of configuring the last autonomous robotic communication relay RCRA(N) positioned on the trajectory T, involving:
reconfiguring a routing table of the RCRA(N) to indicate that the RCRA(N+1) is directly joinable and that the BA is joinable via the new autonomous robotic communication relay RCRA(N+1);
identifying that the Child of the RCRA(N) is the RCRA(N+1); and
reconfiguring a module for transmitting the trajectory of the VM to activate the transmission of the trajectory to the new Child RCRA(N+1) of the RCRA(N).

5. The method as claimed in claim 1, wherein the step of configuring the rear base BA comprises steps involving:
adding the new autonomous robotic communication relay RCRA(N+1) to a list ‘L’ of the RCRAs integrated in the linear wireless mesh network;
reconfiguring a routing table of the BA to indicate that all the RCRAs included in the list ‘L’, other than the new autonomous robotic communication relay RCRA(N+1), are joinable via the new autonomous robotic communication relay RCRA(N+1), and that the moving vehicle VM is joinable via the new autonomous robotic communication relay RCRA(N+1);
identifying that the Parent of the rear base BA is the new autonomous robotic communication relay RCRA(N+1); and
configuring a module for receiving the trajectory of the VM to activate the reception of the trajectory from the new Parent RCRA(N+1).

6. The method as claimed in claim 5, wherein the step of configuring the new autonomous robotic communication relay RCRA(N+1) further comprises a step involving transmitting the entire trajectory T of the VM to the new autonomous robotic communication relay.

7. The method as claimed in claim 1, wherein the step of configuring the autonomous robotic communication relays RCRAs of the linear wireless mesh network further comprises steps allowing each relay positioned along the trajectory T of the VM to:
monitor the quality of the communication link between itself and its Parent; and
autonomously advance on the trajectory T when the quality of the link is below the threshold value S.

8. The method as claimed in claim 7, wherein the monitoring step further comprises a step involving monitoring the distance between itself and its Parent, and the step of advancing involves advancing when the quality of the link is below the threshold value S and the distance between itself and its Parent is greater than a safe distance ds.

9. The method as claimed in claim 1, further comprising a step involving computing a new value S of the quality threshold before the configuration step.

10. The method as claimed in claim 1, further comprising steps allowing progressive and automatic fallback of the autonomous robotic communication relays positioned on the trajectory T of the moving vehicle VM, when a VM turns back along its initial trajectory, with the fallback of the autonomous robotic communication relays leading to dismantling of the linear wireless mesh network.

11. A computer program product, said computer program comprising code instructions for carrying out the steps of the method as claimed in claim 1, when said program is executed on a computer.

12. A device for automatically deploying a communication network between a moving vehicle VM and a rear base BA, the device comprising means for implementing the steps of the method as claimed in claim 1.

13. The device as claimed in claim 12, wherein the moving vehicle is a land or air or amphibious or aquatic vehicle, said vehicle being driven or remotely driven or self-driven.

14. A Software Defined Networking (SDN) controller having a Northbound interface and a Southbound interface, said SDN controller being able to control, via its Southbound Interface, the configurations of SDN appliances and to implement, in the form of an SDN service via its Northbound Interface, the steps of the method as claimed in claim 1, and wherein said SDN appliances are made up of the rear base BA, the moving vehicle VM and the set of autonomous robotic communication relays RCRAs.
